(19) United States
(12) Patent Application Publication
(10) Pub. No.: US 2004/0122157 A1
(43) Pub. Date: Jun. 24, 2004

(54) Rubber composition for tire tread and tire

(76) Inventor: Gerard Labauze, Clermont-Ferrand (FR)

Correspondence Address: BAKER & BOTTS, 30 ROCKEFELLER PLAZA, NEW YORK, NY, 10112

(21) Appl. No.: 10/655,782

(22) Filed: Sep. 5, 2003

Related U.S. Application Data
(63) Continuation of application No. PCT/EP02/02560, filed on Mar. 8, 2002.

(30) Foreign Application Priority Data
Mar. 12, 2001 (FR) 01/03354

(51) Int. Cl. C08K 5/01

(52) U.S. Cl. 524/487; 524/571

(57) ABSTRACT

The present invention relates to a cross-linkable or cross-linked rubber composition which is usable to constitute a tread of a tire, having improved wear resistance. The composition of the present invention is based on one or more diene elastomers and comprises at least one hydrocarbon plasticizing resin which is miscible in the diene elastomer(s), the resin having a Tg of between 10° C. and 150° C. and a molecular weight of between 400 and 2000 g/mol, said composition comprising

a first diene elastomer having a Tg of between −65° C. and −10° C. in a quantity of from 30 to 100 phr,

a second diene elastomer having a Tg of between −110° C. and −80° C. in a quantity of from 70 to 0 phr,

a hydrocarbon plasticizing resin from 5 phr to 35 phr and not based on cyclopentadiene or dicyclopentadiene, and

a plasticizing oil, in a quantity of from 0 phr to 26 phr.

### CROSS-REFERENCE TO RELATED APPLICATIONS

The present application is a continuation of International Patent Application No. PCT/EP02/02560, filed Mar. 8, 2002, published in French on Sep. 19, 2002 as International Patent Publication No. WO 02/072689, and claiming priority to French Patent Application No. FR 01/03354, filed Mar. 12, 2001, all of which are incorporated in their entireties.

### BACKGROUND OF THE INVENTION

The present invention relates to a cross-linkable or cross-linked rubber composition which is usable to constitute a tread of a tire, to such a tread having in particular improved wear resistance, a tread comprising the rubber composition, and a tire incorporating the tread. The invention applies in particular to tires of passenger-vehicle type.

Since fuel economies and the need to preserve the environment have become priorities, it has become desirable to produce mixes having good mechanical properties and as low a hysteresis as possible so that they can be processed in the form of rubber compositions usable for the manufacture of various semi-finished products for tires, such as treads, and are useful in obtaining tires having improved properties, such as reduced rolling resistance.

Numerous solutions have been proposed for reducing the hysteresis of tread compositions and the rolling resistance of tires comprising such compositions. See, for example, U.S. Pat. Nos. 4,550,142, and 5,001,196, EP-A-299 074 and EP-A-447 066.

In addition to the reduction in the rolling resistance, it is equally desirable to improve the wear resistance of the tire treads. Improvement of the wear resistance to increases the lifetime of the tire treads and tires. Thus, the improved wear resistance also contributes to conservation of the environment because the tires are used for longer periods of time, which reduces the quantity of worn tires designated for recycling.

Relatively few solutions have been proposed for improvement of wear resistance. For example, some compositions are described in patent specifications JP-A-61 238501, EP-A-502 728 and EP-A-501 227.

It is well-known to the person skilled in the art that an improvement in one performance type for tires is frequently obtained to the detriment of the other performance types. For example, the use of amorphous or semi-crystalline polymers having a high glass transition temperature (Tg) or melting temperature and a reduced molecular weight in tread compositions improves the grip of the tires having these treads, but can adversely affect the wear resistance of the tire.

U.S. Pat. No. 5,901,766 discloses tread compositions having improved abrasion. These compositions contain: a polybutadiene having a high cis linkage content which has a glass transition temperature (Tg) of −103° C., in a quantity equal to or greater than 50 phr (phr: parts by weight per hundred parts of elastomers), a styrene-butadiene copolymer prepared in emulsion and having a Tg of −55° C., in a quantity less than or equal to 50 phr, a plasticizing resin selected from the group consisting of hydrocarbon resins (including in particular resins of the polydicyclopentadiene type), phenol/acetylene resins (non-hydrocarbon), resins derived from rosin and mixtures of such resins, in a total quantity of resin equal to 15 phr, an aromatic plasticizing oil in a quantity greater than or equal to 28.75 phr, and a reinforcing filler consisting of 70 phr carbon black. Resins may be of the coumarone/indene type or phenol/acetylene type.

However, the composition disclosed in U.S. Pat. No. 5,901,766 contains a relatively high quantity of aromatic plasticizing oil which is a potent polluting agent. Aromatic plasticizing oils have a volatility that contributes to the tendency to be exuded from the tread by compression during prolonged travel.

A general disadvantage common to all the known tread compositions is the relative disparity of the levels of performance achieved by the tires comprising these compositions, specifically rolling resistance and grip, and wear resistance.

Therefore, there exists a need to produce a cross-linkable or cross-linked rubber composition for use in tire treads having environmentally friendly amounts of aromatic plasticizing oil that exhibits improved wear resistance without adversely affecting grip and rolling resistance of the tire comprising the rubber composition.

### SUMMARY OF THE INVENTION

The present invention relates to a cross-linkable or cross-linked rubber composition which is usable to constitute a tread of a tire, having improved wear resistance, a tread comprising the rubber composition and a tire comprising the tread.

The composition of the present invention is based on diene elastomers and comprises a hydrocarbon plasticizing resin which is miscible in the diene elastomer(s), the resin having a Tg of between 10° C. and 150° C. and a molecular weight of between 400 and 2000 g/mol, said composition comprising:

a hydrocarbon plasticizing resin from 5 phr to 35 phr and not based on cyclopentadiene or dicyclopentadiene,

a plasticizing oil, in a quantity of from 0 phr to 26 phr,

a first diene elastomer having a Tg of between −65° C. and −10° C. in a quantity of from 30 to 100 phr, and

a second diene elastomer having a Tg of between −110° C. and −80° C. in a quantity of from 70 to 0 phr.

It is understood that “a” or “the” hydrocarbon plasticizing resin is intended to mean “one or more” resins. Likewise, “a” or “the” diene elastomer is intended to mean one or more diene elastomers.

### DETAILED DESCRIPTION OF THE INVENTION

The object of the present invention is to overcome the undesired properties of the prior art compositions. The inventor has unexpectedly discovered that the association of a hydrocarbon plasticizing resin with a diene elastomer comprising:

30 phr to 100 phr of a first diene elastomer having a glass transition temperature of between −65° C. and −10° C., and

70 phr to 0 phr of a second diene elastomer having a glass transition temperature of between −110° C. and −80° C., and

wherein the hydrocarbon plasticizing resin is present in 5 to 35 phr, miscible in said diene elastomer(s), has a glass transition temperature of between 10 and 150° C., a number-average molecular weight of between 400 g/mol and 2000 g/mol and is not based on cyclopentadiene or dicyclopentadiene,

makes it possible to use a quantity of plasticizing oil, i.e., aromatic, paraffinic or naphthenic, in a quantity which is advantageously less than or equal to 26 phr, or even zero phr.

The cross-linkable or cross-linked rubber composition is usable for a tire tread and exhibits improved wear resistance in comparison to known tires, the treads of which comprise a plasticizing oil as plasticizer. In addition, the tires comprising the rubber composition of the invention exhibits a rolling resistance and a grip on dry and damp ground which are close to the properties exhibited by the prior art tires.

The improvement in the wear resistance involves a reduction in the compaction by compression to which the tread according to the invention is subjected to during travel. Consequently, there is a reduction in the loss of the plasticizing oil, such as the aromatic oil, from the tire.

The use of the rubber composition of the present invention causes a significant reduction in pollution of the environment during travel, which is further minimized by the reduced or absence of oil from the rubber composition according to the invention.

In an embodiment of the present invention, the quantity of oil in the rubber composition according to the invention varies from 0 to 15 phr. Preferably, the composition is devoid of plasticizing oil.

The rubber composition of the present invention comprises diene elastomer(s) having a Tg of between −65° C. and −10° C. in a quantity of from 30 to 50 phr, and diene elastomer(s) having a Tg of between −110° C. and −80° C. in a quantity of from 70 to 50 phr.

As for the hydrocarbon plasticizing resin, it is then present in said composition in a quantity of from 25 to 35 phr.

The presence of hydrocarbon plasticizing resin in the composition according to the present invention imparts improved endurance to a tire incorporating such a composition into its tread. The presence of the resin in the rubber composition of the present invention minimizes the migration of the plasticizing oils, e.g., aromatic, paraffinic or naphthenic oils, into the adjacent mixes of the tire. Consequently, the adverse change in the properties of the adjacent mixtures, such as their rigidity and their resistance to cracking, is minimized. The resistance of the tire to the separation of the triangulation crown plies which it comprises in its crown reinforcement is improved. The resistance to separation of the plies is also referred to as resistance to “cleaving” by the person skilled in the art.

“Diene elastomer” is understood to mean an elastomer resulting at least in part (homopolymer or copolymer) from diene monomers, i.e., monomers bearing two double carbon-carbon bonds, whether conjugated or not.

The diene elastomer of the rubber composition according to the invention is said to be “highly unsaturated.” It has resulted from conjugated diene monomers having a molar content of units resulting from conjugated dienes which is greater than 50%.

The phrase “based on” used to define the constituents of the composition of the present invention and means the mixture and/or the reaction product of these constituents.

In an embodiment of the invention, the rubber composition of the present invention comprises:

a first diene elastomer having a Tg which is between −65° C. and −10° C. selected from the group consisting of styrene-butadiene copolymers prepared in solution, styrene-butadiene copolymers prepared in emulsion, natural polyisoprenes, synthetic polyisoprenes having a cis-1,4 linkage content greater than 95% and mixtures thereof, and

a second diene elastomer having a Tg of between −110° C. and −80° C., preferably having a glass transition temperature of from −105° C. to −90° C., and they comprise butadiene units in an amount equal to or greater than 70%. Even more preferably, this elastomer consists of a polybutadiene having a cis-1,4 linkage content greater than 90%.

According to a preferred embodiment of the invention, the rubber composition comprises said first diene elastomer, a styrene-butadiene copolymer prepared in solution which has a Tg of between −50° C. and −15° C., or a styrene-butadiene copolymer prepared in emulsion having a Tg of between −65° C. and −30° C.

According to one example of embodiment of the invention, said composition comprises a blend of said first diene elastomer and said second diene elastomer.

According to one embodiment of the invention of this example, the rubber composition comprises a blend of polybutadienes having a cis-1,4 linkage content greater than 90% and a styrene-butadiene copolymers prepared in solution.

According to a second embodiment of the invention, the rubber composition comprises a blend of a polybutadiene having a cis-1,4 linkage content greater than 90% and a styrene-butadiene copolymers prepared in emulsion.

According to a third embodiment of the invention, the rubber composition comprises a blend of a polybutadienes having a cis-1,4 linkage content greater than 90% and a natural or synthetic polyisoprene.

With regard to the styrene-butadiene copolymer prepared in emulsion, copolymers having a quantity of emulsifier varying substantially from 1 phr to 3.5 phr may be advantageously used. For example, E-SBR copolymers comprising, respectively, 1.7 phr and 1.2 phr are described in French patent application No. 00 01339.

The plasticizing resin used in the rubber composition according to the invention is an exclusively hydrocarbon resin, comprising only carbon and hydrogen atoms. This resin may be aliphatic and/or aromatic and is miscible in the diene elastomer(s). The resin has a glass transition temperature is between 10 and 150° C., and a number-average molecular weight between 400 and 2000 g/mol.

“Aliphatic” hydrocarbon resins having a hydrocarbon chain of which is formed of C4-C6 fractions containing variable quantities of piperylene, isoprene, mono-olefins and non-polymerizable paraffinic compounds, as defined in the article by M. J. Zohuriaan-Mehr and H. Omidian, J.M.S REV MACROMOL. CHEM. PHYS. C40(1), 23-49 (2000), may be used. Such resins are based on pentene, butene, isoprene, piperylene and comprise reduced quantities of cyclopentadiene or dicyclopentadiene.

It will be noted that the resins of type polycyclopentadiene or polydicyclopentadiene, i.e., those comprising cyclopentadiene or dicyclopentadiene units in a majority proportion, are not usable in a composition according to the present invention. These resins based on dicyclopentadiene are defined in the article by M. J. Zohuriaan-Mehr and H. Omidian, J.M.S REV MACROMOL. CHEM. PHYS. C40(1), 23-49(2000)).

“Aromatic” hydrocarbon resins having a hydrocarbon chain which is formed of aromatic units of styrene, xylene, α-methylstyrene, vinyl toluene or indene, as defined in the article by M. J. Zohuriaan-Mehr and H. Omidian, J.M.S REV MACROMOL. CHEM. PHYS. C40(1), 23-49 (2000) may also be used as a resin. Suitable aromatic resins are based on α-methylstyrene and methylene, and on coumarone and indene

In addition, the intermediate resins of “aliphatic/aromatic” type having a mass fraction of aliphatic units is between 80% and 95% and a mass fraction of aromatic units being between 5% and 20% can also be used.

Preferably, the plasticizing resin of the composition according to the invention has a glass transition temperature of from 30° C. to 100° C., a number-average molecular weight of between 400 and 1000 g/mol, and a polymolecularity index of less than 2.

According to another embodiment of the present invention, the aliphatic resin has a glass transition temperature of from 50° C. to 90° C. and mass fractions of aliphatic and aromatic units which is greater than 95% and less than 3%, respectively, is used as plasticizing resin.

According to one variant embodiment of the invention, an aromatic resin which has a glass transition temperature of from 30 to 60° C. and mass fractions of aliphatic and aromatic units which vary from 30% to 50% and 70% to 50%, respectively, is used as plasticizing resin.

According to another embodiment of the present invention, an aliphatic/aromatic resin having a glass transition temperature of 60° C. and mass fractions of aliphatic and aromatic units of which are 80% and 20%, respectively, is used as plasticizing resin.

The composition according to the present invention also comprises a reinforcing filler present in a quantity varying from 50 to 150 phr.

According to an embodiment of the invention, the composition of the present invention comprises carbon black as reinforcing filler. All the carbon blacks conventionally used in tires, and in particular in treads for these tires, particularly blacks of the type, HAF, ISAF and SAF, are suitable. Non-limiting examples of the blacks are N115, N134, N234, N339, N347 and N375.

According to another embodiment of the present invention, the rubber composition comprises a reinforcing white filler as reinforcing filler.

“Reinforcing white filler” is understood to mean a “white” filler or inorganic filler, particularly a mineral filler. The reinforcing white filler is also referred to as a “clear” filler. The reinforcing white filler is capable, without any means other than an intermediate coupling system, of reinforcing a rubber composition intended for the manufacture of tires. The reinforcing white filler is capable of replacing a conventional filler of tire-grade carbon black in its reinforcement function.

Preferably, all or a majority proportion of the reinforcing white filler is silica (SiO₂). The silica used may be any reinforcing silica known to the person skilled in the art, in particular any precipitated silica having a BET surface area and a CTAB specific surface area both of which are less than 450 m²/g, even if the highly dispersible precipitated silicas are preferred.

Even more preferably, said silica has BET or CTAB specific surface areas both of which are from 80 m²/g to 260 m²/g.

In the present specification, the BET specific surface area is determined in accordance with the method of Brunauer, Emmett and Teller described in “The Journal of the American Chemical Society”, vol. 60, page 309, February 1938, and corresponding to Standard AFNOR-NFT-45007 (November 1987); the CTAB specific surface area is the external surface area determined in accordance with the same Standard AFNOR-NFT-45007 of November 1987.

“Highly dispersible silica” is understood to mean any silica having a very substantial ability to disagglomerate and to disperse in an elastomeric matrix, which can be observed in known manner by electron or optical microscopy on thin sections. Non-limiting examples of such preferred highly dispersible silicas include the silica Perkasil KS 430 from Akzo, the silica BV 3380 from Degussa, the silicas Zeosil 1165 MP and 1115 MP from Rhodia, the silica Hi-Sil 2000 from PPG, the silicas Zeopol 8741 or 8745 from Huber, and treated precipitated silicas such as, for example, the aluminum-“doped” silicas described in application EP-A-0 735 088.

The physical state of the reinforcing white filler is immaterial and may be in the form of a powder, microbeads, granules or balls. Of course, “reinforcing white filler” is also understood to mean mixtures of different reinforcing white fillers, in particular of highly dispersible silicas such as those described above.

The reinforcing white fillers that may also be used, in non-limiting manner, are as follows: aluminas having a formula, Al₂O₃, such as the aluminas of high dispersibility which are described in European Patent Specification EP-A-810 258, and aluminum hydroxides, such as those described in International Patent Specification WO-A-99/28376.

The use of a reinforcing white filler as reinforcing filler in the composition according to the invention makes it possible to improves overall the grip and rolling resistance performance in comparison to the use of carbon black as the filler, and the same improvement in the wear resistance in comparison to known compositions comprising a plasticizing oil as plasticizer.

According to an embodiment of the invention, a blend of a reinforcing white filler and carbon black may be used as reinforcing filler. All the carbon blacks conventionally used in treads for tires, particularly blacks of the type, HAF, ISAF and SAF, are suitable for this purpose. Non-limiting examples of the blacks include N115, N134, N234, N339, N347 and N375.

The carbon blacks which are partially or completely covered with silica are also suitable for constituting the reinforcing filler. Also suitable are carbon blacks modified by silica, such as, although this is not limiting, the reinforcing fillers sold by CABOT under the name “CRX 2000”, which are described in International Patent Specification WO-A-96/37547.

It will be noted that the diene elastomers usable in the composition according to the invention may comprise one or more functional groups specifically active for coupling to said reinforcing filler.

For coupling to carbon black, functional groups comprising a C—Sn bond may be employed. Such groups may be obtained by reaction with an organohalotin functionalizing agent, which corresponds to the general formula R₃SnCl, or with an organodihalotin coupling agent which corresponds to the general formula R₂SnCl₂, or with an organotrihalotin starring agent which corresponds to the general formula RSnCl₃, or of tetrahalotin starring agent which corresponds to the formula SnCl₄, where R is an alkyl, cycloalkyl or aryl radical.

For coupling to the carbon black, amine functional groups, for example obtained using 4,4′-bis-(diethylaminobenzophenone), also referred to as DEAB, may be employed. Examples are shown in patent specifications FR-A-2 526 030 and U.S. Pat. No. 4,848,511.

For coupling to a reinforcing white filler, all the functional, coupled or starred groups which are known to the person skilled in the art for coupling to silica are suitable. Silanol or polysiloxane groups having a silanol end, as described in French patent specification FR-A-2 740 778, may also be used in a non-limiting manner.

FR-A-2 740 778 teaches the use of a functionalizing agent for a living polymer obtained anionically, in order to obtain a function which is active for coupling to silica. This functionalizing agent is formed of a cyclic polysiloxane, such as a polymethylcyclo-tri, -tetra or -deca siloxane, said agent preferably being hexamethylcyclotrisiloxane. The functionalized polymers thus obtained can be separated from the reaction medium resulting in their formation by steam extraction of the solvent, without their macrostructure and their physical properties, changing. Alkoxysilane groups are also suitable.

Mention may be made of the functionalization reaction described in international patent specification WO-A-88/05448 for coupling to silica, which involves reacting on a living polymer obtained anionically an alkoxysilane compound having at least one non-hydrolyzable alkoxy radical. This compound is selected from among the haloalkyl alkoxysilanes.

Mention may also be made of French patent specification FR-A-2 765 882, regarding obtaining alkoxysilane functions. This document discloses the use of a trialkoxysilane, such as 3-glycidoxypropyltrialkoxysilane, for functionalizing a living diene polymer, for coupling to carbon black having silica fixed to its surface as majority reinforcing filler.

In another embodiment of the present invention, the rubber composition further comprises a reinforcing white filler/elastomeric matrix bonding agent or coupling agent, which ensures sufficient chemical and/or physical bonding (or coupling) between the white filler and the matrix, while facilitating the dispersion of the white filler within the matrix.

Such a bonding agent, which is at least bifunctional, has, for example, the simplified general formula “Y—T—X”, in which:

Y represents a functional group (“Y” function) which is capable of bonding physically and/or chemically with the white filler, such a bond possibly being established, for example, between a silicon atom of the coupling agent and the hydroxyl (OH) surface groups of the filler (for example, surface silanols in the case of silica);

X represents a functional group (“X” function) which is capable of bonding physically and/or chemically with the elastomer, for example by means of a sulfur atom;

T represents a hydrocarbon group linking Y and X.

These bonding agents must in particular not be confused with simple agents for covering the filler in question which, in known manner, may comprise the Y function which is active with respect to the filler, but are devoid of the X function which is active with respect to the elastomer.

Such bonding agents, which are of variable effectiveness, have been described in a very large number of documents and are well-known to the person skilled in the art. In fact, it is possible to use any bonding agent known to or likely to provide an effective bond between the silica and the diene elastomer, such as, for example, organosilanes, in particular polysulphurized alkoxysilanes or mercaptosilanes, or polyorganosiloxanes bearing the X and Y functions mentioned above.

The coupling agent preferably used in the rubber compositions according to the invention is a polysulphurized alkoxysilane, which bears two functions referred to as “Y” and “X”, which can be grafted first on the white filler by means of the “Y” function (alkoxysilyl function) and second on the elastomer by means of the “X” function (sulfur function).

In particular, polysulphurized alkoxysilanes, which are referred to as “symmetrical” or “asymmetrical” depending on their specific structure, are used, such as those described for example in patents U.S. Pat. No. 3,842,111, U.S. Pat. No. 3,873,489, U.S. Pat. No. 3,978,103, U.S. Pat. No. 3,997,581, U.S. Pat. No. 4,002,594, U.S. Pat. No. 4,072,701, U.S. Pat. No. 4,129,585, or in the more recent patents U.S. Pat. No. 5,580,919, U.S. Pat. No. 5,583,245, U.S. Pat. No. 5,650,457, U.S. Pat. No. 5,663,358, U.S. Pat. No. 5,663,395, U.S. Pat. No. 5,663,396, U.S. Pat. No. 5,674,932, U.S. Pat. No. 5,675,014, U.S. Pat. No. 5,684,171, U.S. Pat. No. 5,684,172, U.S. Pat. No. 5,696,197, U.S. Pat. No. 5,708,053, U.S. Pat. No. 5,892,085 or EP-A-1 043 357 which describe such known compounds in detail.

So-called “symmetrical” polysulphurized alkoxysilanes which satisfy the following general formula (I) are particularly suitable for implementing the invention:

Z—A—Sₙ—A—Z, (I)

in which:

n is an integer from 2 to 8;

A is a divalent hydrocarbon radical;

Z corresponds to one of the formulae below:

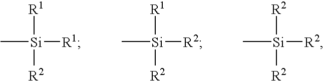

in which:

the radicals R¹, which may or may not be substituted, and may be identical or different, represent a C₁-C₁₈ alkyl group, a C₅-C₁₈ cycloalkyl group, or a C₆-C₁₈ aryl group;

the radicals R², which may or may not be substituted, and may be identical or different, represent a C₁-C₁₈ alkoxy group or a C₅-C₁₈ cycloalkoxyl group.

In formula (I) above, the number n is preferably an integer from 3 to 5.

In the case of a mixture of polysulphurized alkoxysilanes in accordance with Formula (I) above, in particular conventional, commercially available, mixes, the average value of “n” is a fractional number, preferably between 3 and 5, more preferably close to 4.

The radical A, whether substituted or not, is preferably a divalent, saturated or non-saturated hydrocarbon radical, comprising 1 to 18 carbon atoms. In particular C₁-C₁₈ alkylene groups or C₆-C₁₂ arylene groups, more particularly C₁-C₁₀ alkylenes, notably C₂-C₄ alkylenes, in particular propylene, are suitable.

The radicals R¹ are preferably C₁-C₆ alkyl, cyclohexyl or phenyl groups, in particular C₁-C₄ alkyl groups, more particularly methyl and/or ethyl.

The radicals R² are preferably C₁-C₈ alkoxy groups or C₅-C₈ cycloalkoxyl groups, more particularly methoxyl and/or ethoxyl.

Such so-called “symmetrical” polysulphurized alkoxysilanes, and some of the processes for obtaining them, are described, for example, in the recent patents U.S. Pat. No. 5,684,171 and U.S. Pat. No. 5,684,172, which give a detailed list of these known compounds, for n varying from 2 to 8.

Preferably, the polysulphurized alkoxysilane used in the invention is a polysulphide, in particular a tetrasulphide, of bis((C₁-C₄)alkoxysilylpropyl), more preferably of bis(tri(C₁-C₄)alkoxysilylpropyl), in particular of bis(3-triethoxysilylpropyl) or of bis(3-trimethoxysilylpropyl).

As a particularly preferred example, bis(triethoxysilylpropyl) tetrasulphide, or TESPT, of the formula [(C₂H₅O)₃Si(CH₂)₃S₂]₂, is used, which is sold, e.g., by Degussa under the name Si69 (or X50S when it is supported to 50% by weight on carbon black), or alternatively by Witco under the name Silquest A1289 (in both cases, a commercial mixture of polysulphides having an average value of n which is close to 4).

In the rubber compositions according to the invention, the content of polysulphurized alkoxysilane may be within a range of 1 to 15% relative to the weight of reinforcing white filler.

The polysulphurized alkoxysilane may first be grafted (via the “X” function) onto the diene elastomer of the composition of the invention, the elastomer thus being functionalized or “precoupled” and comprising the free “Y” function for the reinforcing white filler. The polysulphurized alkoxysilane may be grafted beforehand (via the “Y” function) on the reinforcing white filler, the thus “precoupled” filler then being able to be bonded to the diene elastomer by means of the free “X” function.

For better processing of the compositions in the uncured state, the coupling agent, either grafted onto the reinforcing white filler, or in the free (i.e. non-grafted) state may be used.

The compositions according to the invention contain, in addition to the aforementioned diene elastomers, plasticizing resin, plasticizing oil, reinforcing filler and reinforcing white filler/elastomer bonding agent, all or part of the other constituents may be used. These constituents include additives commonly used in rubber mixes, such as pigments, antioxidants, antiozone waxes, a cross-linking system based on sulfur and/or peroxide and/or bismaleimides, one or more agents for covering any reinforcing white filler, such as alkyl alkoxysilanes, polyols, amines, amides, etc.

These compositions according to the invention may be prepared using known thermomechanical working processes for the constituents in one or more stages. For example, they may be obtained by thermomechanical working in one stage in an internal mixer which lasts from 3 to 7 minutes, with a speed of rotation of the blades of 50 rpm, or in two stages in an internal mixer which last from 3 to 5 minutes and from 2 to 4 minutes respectively, followed by a finishing stage effected at 80° C., during which the sulfur and the vulcanization accelerators in the case of a composition which is to be sulfur-cross-linked are incorporated.

A tire tread according to the invention is made of said rubber composition according to the invention, and a tire according to the invention comprises this tread.

### EXAMPLES

The aforementioned characteristics of the present invention, as well as others, will be better understood on reading the following description of several examples of embodiment of the invention, which are given by way of illustration and not of limitation.

Materials and Methods

The molecular weights of the resins according to the invention were determined by size exclusion chromatography (SEC).

Size exclusion chromatography or SEC make it possible physically to separate macromolecules according to their size in the swollen state in columns filled with a porous stationary phase. The macromolecules were separated by their hydrodynamic volume, with the bulkiest being eluted first.

Although not an absolute method, SEC enables an assessment to be made of the molecular weight distribution of the resins. On the basis of commercially available standards of polystyrene of low molecular weight (of between 104 and 90000 g/mol), the number-average Mn and weight-average Mw weights were determined and the polydispersity index Ip calculated.

Each sample of resin was solubilized in tetrahydrofuran, at a concentration of 1 g/l.

The apparatus used was a chromatograph “WATERS model Alliance 2690”. The elution solvent was tetrahydrofuran (mobile phase), the flow rate was 1 ml/min., the temperature of the system is 35° C. and the duration of analysis was 40 min. A set of three columns in series, having the respective trade names “WATERS type STYRAGEL HR4E” (mixed-bed column), “WATERS type STYRAGEL HR1” (of a porosity of 100 Angstrom) and “WATERS STYRAGEL HR0.5” (of a porosity of 50 Angstrom) was used for the stationary phase.

The injected volume of the solution of each resin sample is 100 μl. The detector was a “WATERS model 2410” differential refractometer and the chromatographic data processing software is the “WATERS MILLENNIUM” (version 3-2) system.

The glass transition temperatures Tg of the elastomers and plasticizers were measured by means of a differential calorimeter (“differential scanning calorimeter”).

In order to measure Tg for the rubber compositions incorporating these elastomers and these plasticizers, dynamic measurements were carried out at a frequency of 10 Hz and at two different values of stresses (0.2 MPa and 0.7 MPa), which “MDC” measurements were carried out in accordance with ISO Standard 4664 (the mode of deformation being shearing and the test pieces being cylindrical).

The properties of the rubber compositions were measured as follows:

Mooney viscosity: ML(1+4) at 100° C. measured in accordance with Standard ASTM D-1646.

Moduli of elongation ME100 (at 100%) and ME300 (at 300%) measured in accordance with Standard ASTM D 412.

Scott break index: breaking load (MPa) and elongation (in %) measured at 23° C.

Hysteresis losses (HL): measured by rebound at 60° C. (the deformation for the losses measured is 40%).

Dynamic shear properties: measured in accordance with Standard ASTM D2231-71, reapproved in 1977 (measurement as a function of the deformation carried out at 10 Hz with a peak-to-peak deformation of 0.15% to 50%, and measurement as a function of the temperature carried out at 10 Hz under a repetitive stress of 20 or 70 N/cm² with a temperature sweep of −80° C. to 100° C.).

The performance of the tires, the treads of which were based on these rubber compositions, were measured by means of relative performance indices, relative to a reference index 100 characterizing a “control” tire (a performance index greater than this base 100 indicating a performance superior to that of the corresponding “control” tire).

The rolling resistance of each of the tires tested was measured by running on a test drum, at an ambient temperature of 25° C., under a load of 392 daN and at a speed of 80 km/h, the internal pressure of the tire being 2.1 bar.

The wear resistance of each tire was determined by means of a relative wear index which is a function of the height of rubber remaining, after running on a winding road circuit. Alternatively, in the case of Example 4, the wear resistance was determined on a hard-wear circuit which is very winding, with the covering of which is characterized by micro-roughnesses. The running occurred at an average speed of 77 km/h until the wear reached the wear indicators located in the grooves in the treads. For each of Examples 1 to 4, this relative wear index was obtained by comparing the height of rubber remaining on a tread according to the invention with the height of rubber remaining on a “control” tread, which by definition has a wear index of 100.

The grip of each tire tested was evaluated by measuring braking distances in “two wheels locked” braking mode and in “ABS” braking mode, both on dry ground and on damp ground. More precisely, the braking distance in “two wheels locked” mode was measured going from a speed of 40 km/h to a speed of 0 km/h, both on dry ground and on damp ground, whereas the braking distance in “ABS” mode was measured, on dry ground, going from a speed of 70 km/h to 20 km/h and, on damp ground, going from a speed of 40 km/h to 10 km/h.

The behavior on damp ground of each tire was evaluated by the time taken to travel a wetted winding road circuit.

The resistance of the tires to the separation of the crown plies was also evaluated by means of relative performance indices, relative to a reference index 100 characterizing a “control” tire (a performance index greater than this base 100 indicating a superior performance to that of the corresponding “control” tire).

This resistance was measured by a running test on a test drum, the surface of which was provided with obstacles (bars and “polars” which stress the edges of the belt of the tire formed of two working crown plies WCP1 and WCP2), at an ambient temperature of 20° C., under a load of 490 daN or 569 daN, as shown in Examples 3 and 5, respectively. The test was run at a speed of 75 km/nh, and the internal pressure of the tire being set to 2.5 bar. This test was stopped when a deformation of the crown reinforcement of the tire was detected.

Each tire had first been “baked” (unmounted) for 4 weeks at 65° C.

The results obtained are expressed in the form of a mileage performance (base 100 for the average of the two “control” tires) and of an average cracked length (in mm) between the two crown plies WCP1 and WCP2.

### Example 1

A “control” rubber composition T1 and a rubber composition in accordance with the invention I1 were prepared, each being intended to constitute a tread of a “passenger-vehicle”-type tire. Table 1 below contains:

the formulation of each of these compositions T1 and I1;

the properties of each composition T1 and I1 in the non-vulcanized and vulcanized states;

the performances of tires, the respective treads of which were formed of these compositions T1 and I1.

TABLE 1

| | |
|---|---|
| COMPOSITION T1 | COMPOSITION I1 |

FORMULATION

| | | |
|---|---|---|
| Elastomeric matrix | S-SBR A (70 phr) | S-SBR A (57.5 phr) |
| | BR A (30 phr) | BR A (42.5 phr) |
| Reinforcing filler | Silica 1165 MP (90 phr) | Silica 1165 MP (90 phr) |
| Silane bonding agent “Si69” | 7.2 phr | 7.2 phr |
| (from Degussa) | | |
| DPG (diphenylguanidine) | 1.5 phr | 1.5 phr |
| Total aromatic oil | 40 phr | 25 phr |
| Plasticizing resin R1 | 0 phr | 15 phr |
| Stearic acid/ZnO | 2 phr/2.5 phr | 2 phr/2.5 phr |
| Antioxidant (6PPD) | 2 phr | 2 phr |
| sulfur/accelerator (CBS)° | 1 phr/2.0 phr | 1 phr/2.0 phr |

PROPERTIES

| | | |
|---|---|---|
| ML(1 + 4) at 100° C. | 113 | 109 |
| Shore A | 61 | 60 |
| ME100 at 23° C. | 1.54 | 1.47 |
| HL at 60° C. | 26.5 | 26.5 |

Dynamic properties at 10 Hz, at 0.2 MPa and at 0.7 MPa stress

| | | |
|---|---|---|
| Tg (MDC at 0.2 MPa) in ° C. | −42.8 | −45.3 |
| Tg (MDC at 0.7 MPa) in ° C. | −19.5 | −19.2 |

PERFORMANCES OF THE TIRES (175/70 R14 “MXT”)

| | | |
|---|---|---|
| Wear resistance | 100 | 110 |
| (at 7° C. on wet ground at 21%, | | |
| for a Citroen Xantia 1.8 l) | | |
| Grip | | |
| (at 23° C. for a | | |
| Renault Laguna 2 l) | | |
| braking dry ground ABS | 100 | 100 |
| braking dry ground wheels locked | 100 | 100 |
| braking wet ground ABS | 100 | 102 |
| braking wet ground wheels locked | 100 | 99 |
| Behavior on wet ground | 100 | 100 |
| (at 13° C., for a Golf 75) | | |
| Rolling resistance (9.2 kg/tonne) | 100 | 99 |

S-SBR A was a styrene-butadiene copolymer prepared in solution having:

a 1,2 linkage content of 58%,

a styrene linkage content of 25%,

a trans linkage content of 23%,

a Mooney viscosity ML(1+4) at 100° C. of 54,

a quantity of extender oil equal to 37.5 phr, and

a glass transition temperature Tg of −30° C.

BR A was a polybutadiene having:

a very high cis-1,4 linkage content of approximately 93%, and

a glass transition temperature Tg of −103° C.

Plasticizing resin R1 was a resin sold by Cray Valley under the name “W100”, having:

an aliphatic linkage content of 49%,

an aromatic linkage content of 51%,

number-average Mn and weight-average Mw molecular weights respectively of 750 g/mol and 1300 g/mol, and

a glass transition temperature Tg of 55° C.

6PPD was N-(1,3-dimethylbutyl)-N′-phenyl-p-phenylenediamine, and CBS: N-cyclohexyl-benzothiazyl sulphenamide.

It will be noted that the Tg of the composition I1 according to the invention under a dynamic stress of high modulus (0.7 MPa) was made substantially equal to the corresponding Tg of the “control” composition T1.

As can be seen in Table 1, the variance (0.3° C.) between the Tg of the compositions I1 and T1 which were measured at a dynamic stress of reduced modulus, equal to 0.2 MPa, was close to the variance (2.5° C.) between the Tg of said compositions I1 and T1 which were measured under said stress of high modulus.

This absence of discrepancy between the Tg when passing from a stress of high modulus to a stress of reduced modulus conveys the fact that the resin R1 was readily miscible in the elastomeric matrix constituted by S-SBR A and BR A.

The performance results of the tires show that the incorporation of a plasticizing resin of a Tg equal to 55° C. and of an Mn equal to 750 g/mol in the tread composition I1 comprising silica as reinforcing filler make it possible to improve the wear resistance of a tire, when the tread of which was formed of said composition I1, due to the aforementioned miscibility of the resin according to the invention, without adversely affecting the grip on dry or damp ground of the tires, the behavior of a vehicle fitted with these tires and the running resistance of the tires.

It will be noted that this composition I1 comprises plasticizing oil in a quantity which was significantly reduced compared with that which characterizes the composition T1.

### Example 2

A “control” tread composition T2 and a composition according to the invention I2 were prepared, for tires of “top-of-the-range passenger-vehicle” type. In the manner of Example 1, Table 2 below shows the results obtained:

TABLE 2

| | |
|---|---|
| COMPOSITION T2 | COMPOSITION I2 |

FORMULATION

| | | |
|---|---|---|
| Elastomeric matrix | S-SBR B (50 phr) | S-SBR B (70 phr) |
| | S-SBR C (50 phr) | S-SBR D (30 phr) |
| Reinforcing filler | Silica 1165 MP (45 phr) | Silica 1165 MP (45 phr) |
| | Black N234 (45 phr) | Black N234 (45 phr) |
| Silane bonding agent “Si69” | 3.8 phr | 3.8 phr |
| (from Degussa) | | |
| DPG (diphenylguanidine) | 1 phr | 1 phr |
| Total aromatic oil | 45 phr | 25.5 phr |
| Plasticizing resin R2 | 0 phr | 18 phr |
| Stearic acid/ZnO | 1 phr/3.0 phr | 1 phr/3.0 phr |
| Antioxidant (6PPD) | 2 phr | 2 phr |
| sulfur/accelerator (CBS)° | 1 phr/2 phr | 1 phr/2 phr |

PROPERTIES

| | | |
|---|---|---|
| ML(1 + 4) at 100° C. | 98 | 100 |
| Shore A | 66 | 66 |
| ME100 at 23° C. | 1.78 | 1.54 |
| HL at 60° C. | 37.0 | 44.8 |

Dynamic properties at 10 Hz, at 0.2 MPa and at 0.7 MPa stress

| | | |
|---|---|---|
| Tg (MDC at 0.2 MPa) in ° C. | −25 | −31 |
| Tg (MDC at 0.7 MPa) in ° C. | −5 | −10 |

PERFORMANCES OF THE TIRES (235/45 ZR17 “SX MXX3”)

| | | |
|---|---|---|
| Wear resistance | 100 | 110 |
| (at 10° C. on wet ground at 15%, | | |
| for a BMW 730) | | |
| Grip | | |
| (at 25° C. for | | |
| a Mercedes 300 E) | | |
| braking dry ground ABS | 100 | 105 |
| braking dry ground wheels locked | 100 | 106 |
| braking wet ground ABS | 100 | 102 |
| braking wet ground wheels locked | 100 | 95 |
| Behavior on wet ground | 100 | 101 |
| (at 13° C., for a Golf 75) | | |
| Rolling resistance (12.1 kg/tonne) | 100 | 97 |

S-SBR B was a styrene-butadiene copolymer prepared in solution having

a styrene linkage content of 29%,

a trans-1,4 linkage content of 78%,

a Mooney viscosity ML(1+4) at 100° C. of 58,

a quantity of extender oil equal to 37.5 phr, and

a glass transition temperature Tg of −50° C.

S-SBR C was a styrene-butadiene copolymer prepared in solution having

a 1,2 linkage content of 24%,

a styrene linkage content of 40%,

a Mooney viscosity ML(1+4) at 100° C. of 54,

a quantity of extender oil equal to 37.5 phr, and

a glass transition temperature Tg of −30° C.

S-SBR D was a styrene-butadiene copolymer prepared in solution having

a styrene linkage content of 27.5%,

a trans-1,4 linkage content of 78%,

a Mooney viscosity ML(1+4) at 100° C. of 54, and

a glass transition temperature Tg of −50° C.

Plasticizing resin R2 was a resin sold by HERCULES under the name “R2495”, having:

an aliphatic linkage content of 97%,

an aromatic linkage content of 0%,

number-average Mn and weight-average Mw molecular weights respectively of 820 g/mol and 1050 g/mol, and

a glass transition temperature Tg of 88° C.

It will be noted that the Tg of the composition I2 according to the invention under a dynamic stress of high modulus (0.7 MPa) was set relatively close to the corresponding Tg of the “control” composition T2.

As shown in Table 2, the variance (5° C.) between the Tg of the compositions I2 and T2 which were measured at a dynamic stress of reduced modulus, equal to 0.2 MPa, was close to the variance (6° C.) between the Tg of said compositions I2 and T2 which were measured under said stress of high modulus.

This absence of discrepancy between the Tg when passing from a stress of high modulus to a stress of reduced modulus conveys the fact that the resin R2 was readily miscible in the elastomeric matrix constituted by S-SBR B and S-SBR D.

The performance results of the tires show that the incorporation of a plasticizing resin of a Tg equal to 88° C. and of an Mn equal to 820 g/mol in the tread composition I2 comprising, as reinforcing filler, a blend of 50% silica and 50% carbon black make it possible to improve the wear resistance and the grip on dry ground of a tire of “top-of-the-range” type, when the tread of which is formed of said composition I2, due to the aforementioned miscibility of the resin according to the invention. In addition, the composition did not adversely affect the grip on damp ground of the tires, the behavior on damp ground of a vehicle fitted with these tires and the rolling resistance of the tire.

It will be noted that this composition I2 comprises plasticizing oil in a quantity which was significantly reduced compared with that which characterizes the composition T2.

### Example 3

A “control” tread composition T3 and a composition according to the invention I3 were prepared, for “passenger-vehicle” tires. Table 3 sets forth the results obtained:

TABLE 3

| | |
|---|---|
| COMPOSITION T3 | COMPOSITION I3 |

FORMULATION

| | | |
|---|---|---|
| Elastomeric matrix | BR A (42.5 phr) | BR A (67.5 phr) |
| | S-SBR E (57.5 phr) | S-SBR E (32.5 phr) |
| Reinforcing filler | Silica 1165 MP (80 phr) | Silica 1165 MP (80 phr) |
| Silane bonding agent “Si69” | 6.4 phr | 6.4 phr |
| (from Degussa) | | |
| DPG (diphenylguanidine) | 1.5 phr | 1.5 phr |
| Total aromatic oil | 30 phr | 0 phr |
| Plasticizing resin R2 of Example 2 | 0 phr | 30 phr |
| Stearic acid/ZnO | 2 phr/2.5 phr | 2 phr/2.5 phr |
| Antioxidant (6 PPD) | 2 phr | 2 phr |
| sulfur/accelerator (CBS)° | 1 phr/2.0 phr | 1 phr/2.0 phr |

PROPERTIES

| | | |
|---|---|---|
| ML(1 + 4) at 100° C. | 75 | 96 |
| Shore A | 61.5 | 61.5 |
| ME100 at 23° C. | 1.33 | 1.29 |
| ME300 at 23° C. | 1.57 | 1.39 |
| HL at 60° C. | 27.2 | 32.1 |
| | (at 48.6% deformation) | (at 46.7% deformation) |
| Scott break index at 23° C. | 680/22.2 | 720/21.6 |
| (elongation %/breaking load in MPa) | | |

Dynamic properties at 10 Hz, at 0.2 MPa and at 0.7 MPa stress

| | | |
|---|---|---|
| Tg (MDC at 0.2 MPa) in ° C. | −40 | −43 |
| Tg (MDC at 0.7 MPa) in ° C. | −22 | −22 |

PERFORMANCES OF THE TIRES (175/70 R14 “MXT”)

| | | |
|---|---|---|
| Wear resistance: front/rear axles | 100/100 | 107/105 |
| (at 7° C. on wet ground at 21%, | | |
| for a Citroen Xantia 1.8 l) | | |
| Grip | | |
| (at 23° C. for a | | |
| Renault Laguna 2 l) | | |
| braking dry ground ABS | 100 | 100 |
| braking wet ground ABS | 100 | 100 |
| Behavior on wet ground | 100 | 100 |
| (at 13° C., for a Golf 75) | | |
| Rolling resistance at 25° C. | 100 | 95.3 |

Resistance of the tires (175/70 R14 “MXT”) to separation of the crown plies

| | | |
|---|---|---|
| Mileage performance | 100 | 135 |
| Average cracked length (mm) | 23 | 19 |

S-SBR E was a styrene-butadiene copolymer prepared in solution having

a styrene linkage content of 25%,

a 1,2 linkage content of 58%,

a Mooney viscosity ML(1+4) at 100° C. of 54,

a quantity of extender oil equal to 0 phr, and

a glass transition temperature Tg of −30° C.

It will be noted that the Tg of the composition I3 according to the invention under a dynamic stress of high modulus (0.7 MPa) was made equal to the corresponding Tg of the “control” composition T3.

As can be seen in Table 3, the variance (3° C.) between the Tg of the compositions I3 and T3 which were measured at a dynamic stress of reduced modulus, equal to 0.2 MPa, was relatively close to the zero variance between the Tg of said compositions I3 and T3 which were measured under said stress of high modulus.

This absence of discrepancy between the Tg when passing from a stress of high modulus to a stress of reduced modulus conveys the fact that the resin R2 was readily miscible in the elastomeric matrix constituted by BR A and S-SBR E.

The performance results of the tires show that the incorporation, in a quantity of 30 phr, of a plasticizing resin of a Tg equal to 88° C. and of an Mn equal to 820 g/mol in the tread composition I3 which comprises silica as reinforcing filler and is advantageously completely devoid of plasticizing oil make it possible to improve the wear resistance of a tire, the tread of which was formed of said composition I3, due to the aforementioned miscibility of the resin according to the invention. The composition did not adversely affect the grip on dry or damp ground of the tires, the behavior on damp ground of a vehicle fitted with such tires and did not substantially adversely affect the running resistance of the tire.

It will be noted that this miscibility makes it possible to obtain the aforementioned advantageous results for a tread composition in which the plasticizing oil (aromatic in particular) is completely replaced by said resin, said composition thus contributing to conserving the environment significantly during running.

The results of Table 3 also show that the hydrocarbon plasticizing resin according to the invention which characterizes the tread composition I3 according to the invention makes it possible to improve the resistance to separation of the crown plies of the tire, the tread of which is formed by said composition I3.

### Example 4

A “control” tread composition T4 and a composition not in accordance with the invention NC4 were prepared, for “passenger-vehicle” tires. Table 4 sets forth the results obtained:

TABLE 4

| | |
|---|---|
| COMPOSITION T4 | COMPOSITION NC4 |

FORMULATION

| | | |
|---|---|---|
| Elastomeric matrix | BR A (40 phr) | BR A (60 phr) |
| | S-SBR E (60 phr) | S-SBR E (40 phr) |
| Reinforcing filler | Silica 1165 MP (90 phr) | Silica 1165 MP (90 phr) |
| Silane bonding agent “Si69” | 7.2 phr | 7.2 phr |
| (from Degussa) | | |
| DPG (diphenylguanidine) | 1.5 phr | 1.5 phr |
| Total aromatic oil | 40 phr | 25 phr |
| Plasticizing resin R3 | 0 phr | 15 phr |
| Stearic acid/ZnO | 2 phr/2.5 phr | 2 phr/2.5 phr |
| Antioxidant (6 PPD) | 2 phr | 2 phr |
| sulfur/accelerator (CBS)° | 1 phr/2.0 phr | 1 phr/2.0 phr |

PROPERTIES

| | | |
|---|---|---|
| ML(1 + 4) at 100° C. | 90 | 86 |
| Shore A | 65 | 62 |
| ME100 at 23° C. | 1.60 | 1.10 |
| ME300 at 23° C. | 1.80 | 1.10 |
| HL at 60° C. | 27.5 | 38 |
| | (at 43% deformation) | (at 52% deformation) |
| Scott break index at 23° C. | | |
| (elongation %/breaking load in MPa) | 660/22.2 | 820/20.6 |

Dynamic properties at 10 Hz, at 0.2 MPa and at 0.7 MPa stress

| | | |
|---|---|---|
| Tg (MDC at 0.2 MPa) in ° C. | −42 | −58 |
| Tg (MDC at 0.7 MPa) in ° C. | −23 | −24 |

PERFORMANCES OF THE TIRES (175/70 R14 “MXT”)

| | | |
|---|---|---|
| Wear resistance: front/rear axles | 100/100 | 86/82 |
| (at 7° C. on wet ground at 9%, | | |
| for a Citroen Xantia 1.8 l) | | |
| Grip | | |
| (at 23° C. for a | | |
| Renault Laguna 2 l) | | |
| braking dry ground ABS | 100 | 100 |
| braking wet ground ABS | 100 | 100 |
| Behavior on wet ground | 100 | 99 |
| (at 13° C., for a Golf 75) | | |
| Rolling resistance at 25° C. | 100 | 94 |

Plasticizing resin R3 was a resin of polydicyclopentadiene type sold by NISSEKI under the name “EP100”, having:

an aliphatic linkage content of 86%,

a number-average molecular weight Mn of 800 g/mol, and

a glass transition temperature Tg of 75° C.

It will be noted that the Tg of composition NC4 which is not in accordance with the invention under a dynamic stress of high modulus (0.7 MPa) was made substantially equal to the corresponding Tg of the “control” composition T4.

As can be seen in Table 4, the variance (16° C.) between the Tg of the compositions NC4 and T4 which were measured at a dynamic stress of reduced modulus, equal to 0.2 MPa, was very different from the variance (1° C.) between the Tg of said compositions NC4 and T4 which were measured under said stress of high modulus.

This considerable discrepancy between the Tg when passing from a stress of high modulus to a stress of reduced modulus conveys the fact that the resin R3 was not miscible in the elastomeric matrix constituted by the BR A and the S-SBR E.

The performance results of the tires show that the incorporation, in an elastomeric matrix according to the invention reinforced with silica, of a hydrocarbon plasticizing resin which has a Tg and a molecular weight which was close to those of the resins according to the invention but which was not miscible with said elastomeric matrix does not make it possible to improve the wear resistance of the corresponding tread of a tire. On the contrary, this composition was extremely adversely affected due to the aforementioned lack of miscibility of the resin which was not in accordance with the invention.

It will also be noted that the grip on dry or damp ground of these tires, the tread of which comprises this resin which was not in accordance with the invention, was not improved in compensation, and adversely affected the behavior on wet ground of a vehicle fitted with these tires and for the rolling resistance of the tire.

### Example 5

A “control” tread composition T5 and a composition according to the invention I5 were prepared, for “passenger-vehicle” tires. Table 5 sets forth the results obtained:

TABLE 5

| | |
|---|---|
| COMPOSITION T5 | COMPOSITION I5 |

FORMULATION

| | | |
|---|---|---|
| Elastomeric matrix | BR A (42.5 phr) | BR A (50 phr) |
| | S-SBR E (57.5 phr) | S-SBR E (50 phr) |
| Reinforcing filler | Silica 1165 MP (80 phr) | Silica 1165 MP (80 phr) |
| | Black N234 (10 phr) | Black N234 (10 phr) |
| Silane bonding agent “Si69” | 6.4 phr | 6.4 phr |
| (from Degussa) | | |
| DPG (diphenylguanidine) | 1.5 phr | 1.5 phr |
| “High viscosity” aromatic oil | 39.5 phr | 22.5 phr |
| Plasticizing resin R2 of Example 2 | 0 phr | 17 phr |
| Stearic acid/ZnO | 2 phr/2.5 phr | 2 phr/2.5 phr |
| Antioxidant (6 PPD) | 1.9 phr | 1.9 phr |
| sulfur/accelerator (CBS)° | 1.1 phr/2.0 phr | 1.1 phr/2.0 phr |

Resistance of the tires (195/65 R14 “MXT”) to separation of the crown plies

| | | |
|---|---|---|
| Mileage performance | 100 | 129 |

These results show that the hydrocarbon plasticizing resin according to the invention which characterizes the tread composition I5 according to the invention makes it possible to improve the resistance to separation of the crown plies of the tire, the tread of which was formed by said composition I5.

1. A cross-linkable or cross-linked rubber composition which is usable for constituting a tire tread, said composition being based on a diene elastomer and a hydrocarbon plasticizing resin which (i) is not based on cyclopentadiene or dicyclopentadiene, (ii) is miscible in said diene elastomer, (iii) has a glass transition temperature of between 10° C. and 150° C. and (iv) has a number-average molecular weight of between 400 g/mol and 2000 g/mol, wherein said composition comprises:
from 30 to 100 phr of a first diene elastomer having a glass transition temperature (Tg) of between −65° C. and −10° C.;
from 70 to 0 phr of a second diene elastomer having a glass transition temperature (Tg) of between −110° C. and −80° C.;
from 5 phr to 35 phr of a hydrocarbon plasticizing resin; and
from 0 phr to 26 phr of a paraffinic, aromatic or naphthenic plasticizing oil.

2. The rubber composition according to claim 1, wherein the composition comprises said plasticizing oil in a quantity of from 0 phr to 15 phr.

3. The rubber composition according to claim 2, wherein the composition is devoid of said plasticizing oil.

4. The rubber composition according to claim 2, wherein said first diene elastomer is present in a quantity of from 30 to 50 phr, and said second diene elastomer is present in a quantity of from 70 to 50 phr.

5. The rubber composition according to claim 3, wherein said hydrocarbon plasticizing resin is present in a quantity of from 25 phr to 35 phr.

6. The rubber composition according to claim 1, wherein the rubber composition further comprises a reinforcing filler.

7. The rubber composition according to claim 6, wherein the reinforcing filler is a reinforcing white filler.

8. The rubber composition according to claim 6, wherein the reinforcing filler is a blend of carbon black and a reinforcing white filler.

9. The rubber composition according to claim 1, wherein said first diene elastomer is selected from the group consisting of solution-prepared styrene-butadiene copolymers, emulsion-prepared styrene-butadiene copolymers, natural polyisoprenes, synthetic polyisoprenes having a cis-1,4 linkage content greater than 95% and mixtures thereof, and said second diene elastomer comprises a polybutadiene having a cis-1,4 linkage content greater than 90%.

10. The rubber composition according to claim 9, wherein said composition comprises a solution-prepared styrene-butadiene copolymer which has a Tg of between −50° C. and −15° C.

11. The rubber composition according to claim 9, wherein said composition comprises an emulsion-prepared styrene-butadiene copolymer which has a Tg of between −65° C. and −30° C.

12. The rubber composition of claim 1, wherein said composition comprises a blend of said first and second diene elastomer.

13. The rubber composition according to claim 12, wherein said first diene elastomer is a solution-prepared styrene-butadiene copolymer and said second diene elastomer is a polybutadiene having a cis-1,4 linkage content greater than 90%.

14. The rubber composition according to claim 1, wherein said hydrocarbon plasticizing resin has a glass transition temperature of from 30° C. to 100° C.

15. The rubber composition according to according to claim 1, wherein said hydrocarbon plasticizing resin has a number-average molecular weight of between 400 and 1000 g/mol, and a polymolecularity index less than 2.

16. A tread for a tire comprising the rubber composition in accordance with claim 1.

17. A tire comprising a tread according to claim 16.
